(19) United States
(12) Patent Application Publication
(10) Pub. No.: US 2013/0204779 A1
(43) Pub. Date: Aug. 8, 2013

(54) Monetizing a social networking website

(71) Applicants: Yorgos Dionysus Marinakis, Rio Rancho, NM (US); Michael Anthony Martinez, Albuquerque, NM (US)

(72) Inventors: Yorgos Dionysus Marinakis, Rio Rancho, NM (US); Michael Anthony Martinez, Albuquerque, NM (US)

(73) Assignee: Cobalt Monkey, LLC, Albuquerque, NM (US)

(21) Appl. No.: 13/760,528

(22) Filed: Feb. 6, 2013

Related U.S. Application Data
(60) Provisional application No. 61/595,686, filed on Feb. 7, 2012.

(51) Int. Cl. G06Q 20/22; G06Q 50/00

(52) U.S. Cl. CPC G06Q 20/22; G06Q 50/01
USPC 705/39

(57) ABSTRACT

A method enabling social networking website providers to monetize a social networking website, comprising charging users for posting content per posting action. A social networking website graphical user interface component comprising an indicator, wherein a user's indicator displays a balance of funds in an account held by the user on the social networking website, wherein the user's indicator decrements proportionately whenever the user's account is debited, wherein the user's indicator increments proportionately whenever the user's account is credited.

### CROSS-REFERENCE TO RELATED APPLICATIONS

Provisional 61/586,835, filed 15 Jan. 2012; provisional 61/595,686, filed 7 Feb. 2012.

### STATEMENTS REGARDING FEDERALLY SPONSORED RESEARCH AND DEVELOPMENT

Not applicable.

### BACKGROUND

The embodiments of the present invention satisfy the needs of monetizing a social network website, in particular how to monetize a technology within a social network website.

Information relevant to attempts to address these problems can be found in U.S. Pat. Nos. 8,296,192; 8,296,189; 8,281,233; 8,260,687; 8,103,553; 8,065,193; 8,024,317; 8,055,552; 8,090,666; 7,971,155; 7,620,636; 5,960,411; and U.S. Patent Application No.'s 20120209677; 20110066506; 20100332330; 20090222322; 20090210291; which are not admitted to be prior art with respect to the present invention by its mention in this Background Section. However, it is desirable to have a better method, system and device than is disclosed in the references.

At present, all strategies for monetizing social networks depend on selling advertisement placements. The ads are usually selected based on either the profile data provided by the participant; or based on the text being entered by the participant in a status update, comment to a graphic, in a Tweet, etc. The advertiser hopes that the targeted advertisement will have a higher rate of success than a randomly placed mass market advertisement. Facebook for example reportedly has $4 b in annual revenue and with reportedly 800 million users (Wall Street Journal, Nov. 29, 2011, “Facebook targets huge IPO”), that adds up to an average of only $5 revenue per user per year. Twitter reportedly expected up to $150 m in revenues in 2011 (Bloomberg Businessweek, Jan. 24, 2011, “Twitters ad revenue may triple to $150 million, telemarketer says”). With more than 200 m registered users annually (Wall Street Journal, Feb. 10, 2011, “Twitters suitors talk in billions”) and 200m tweets daily (Twitter blog, Jun. 30, 2011), that adds up to $0.75 revenue per user per year, or $0.002 per tweet. Clearly there are opportunities to further monetize social networks and the technologies in them.

As social networks “go public,” the pressures to monetize will increase. The recent Facebook application for IPO is a case in point. In a Feb. 3, 2012 Wall Street Journal article entitled “Facebook and Zynga: Sharing Riches Isn't Always Easy,” it is noted that 12% of Facebook's revenues come from Zynga, and that doesn't count revenues for placing ads on pages generated by Zynga's games. This dependence disturbed some investors. “If you're Facebook, you can't bank on 12% of your revenues coming from a single source.” According to its IPO filing, Facebook derived 85% of its 2011 revenue from online advertising. Moreover, as social network websites proliferate and cannibalize each other, their individual revenues will come under increased competitive pressure and they will need to find other ways besides advertising to maintain and grow revenues. “The world can absorb more social media networks, but how many? In addition, nearly all rely on advertising (including searches of their privately controlled or “walled” content) for revenue. Advertisers want to see volume and results. Because of the power of network effects and positive feedback, a relatively small number of sites will probably draw most of the user traffic and advertising dollars. So a large number of social networking businesses cannot survive with a traditional advertising business model, unless they are non-profit or no-profit. Of greater concern from the business point of view is that advertisers on social media sites such as Facebook get poor responses—about one-fiftieth the click-through rates compared to what Google sees for its sponsored ads along with Internet searches” (Michael A. Cusumano. April 2011. Technology Strategy and Management: Platform Wars Come to Social Media. COMMUNICATIONS OF THE ACM 54 (4): 31-33). Thus, current versions of social network websites may remain free to use, but next-generation versions may not.

Another issue that may eventually reduce the precision targeting of advertisements, and therefore reduce revenues, is the public and regulatory backlash against using people's data to aggressively monetize the social network. Under a recent Federal Trade Commission order, Facebook is required to undergo an external audit of its privacy policies every two years. This, because it had been making information public that it had pledged to keep private (Babbage, Nov. 29, 2011, The Economist, Facebook and Privacy: walking the tightrope). Similar action can be expected from the European Union: “” (Cassandra, Dec. 8, 2011, The Economist, Regulators and social media: The EU prepares to poke Facebook).

One common suggestion for monetizing social networks is the paid subscription model. In this approach, users would pay a fee to use the site, possibly on a sliding scale based on their number of connections, text postings, message sent, and photos and videos posted; or possibly simply for access.

One form of interaction on or participation in a social network website is “messaging,” but there are other forms of interaction or participation that involve: “posting status updates” and/or “tweeting” and/or “Reply” tweeting with or without accompanying electronic files; “posting comments” on uploaded electronic files such as digital photographs and videos, where the comments are displayed in a stack in temporal order; and endorsing a comment, an uploaded file (e.g., digital photograph), an html hyperlink, an identity on a social network, etc. An “identity on a social network” is an individual or organization for which there exists a webpage on that social network. These are also called user profiles. Each social network provides its own way to perform endorsements, that is, endorse a comment, file, html hyperlink, identity, or something else, on that social network. On Facebook, you “Like” an identity. On Twitter you “Follow” an identity. On Google+you “+1” an identity. Google will soon allow you to “Share” (patent application 20100332330). On Twitter you can “Retweet” a post, which has the effect of endorsing the post. These examples are not intended to limit the present invention. It should be possible, for example, to comment on or endorse someone else's endorsement. The “Like” button (and other endorsement mechanisms, such as Follow and Retweet, and +1) meets an unmet need of advertisers; namely, it provides advertisers with feedback from consumers regarding which advertisements are effective (Andy Kessler, Feb. 2, 2012, “The Button that Made Facebook Billions,” Wall Street Journal). The “like” button also provides increased opportunities for interaction between participants in the social network website.

The embodiments of the present invention disclose a method for monetizing a social network, which method does not depend on advertising revenues or subscription fees. Rather, the present method utilizes a transaction-based fee schedule. We call it “pay-to-participate.” The user or participant pays by the comment, status update, uploaded file, or endorsement. This is the opposite of current trends, which is where corporations and organizations pay people to post comments and files on social networks and blogs; and as discussed above, trends to the opposite of the practice of relying mainly on advertising for revenues. Facebook's recent big revenue innovation, for example, is a form of advertising they call “Sponsored Stories”: “regular News Feed stories that have been promoted to the right column of Facebook, where you may be more likely to discover new things that your friends are interested in. These stories only show up for friends, so you can learn about places to go, apps to use, games to play and organizations your friends like” (http://www.facebook.com/ads/stories/). Google's “Share” button, disclosed in their patent application 20100332330, is apparently their response to Facebook's “Like” button. This button also based on advertising, and it contains the additional innovation of giving a portion of revenue generated by sharing to the people doing the sharing.

U.S. Pat. Nos. 8,065,193, 8,103,553, 8,296,189 and 8,296,192 cover the situation where you are one of dozens or hundreds of people commenting on a blog or news post, and you want to make your comment stand out. The patent discloses the idea of allowing you to “to alter a comment from the default format to a distinctive format for a predetermined fee,” that is, make it bold and in a bigger font. In the 2009 article “Would you pay to comment on a news site?” <http://editdesk.wordpress.com/2009/03/30/comments-pay/>, it is mentioned that “John Robinson of the News & Record in Greensboro, N.C.” “floated the idea” of charging to comment on news posts. Similarly, in 2010, the Sun Chronicle of Massachusetts, in order to “encourage intelligent and meaningful conversation,” required participants to register with their full name, address, phone number, email and credit card number; and required them to verify their identity by using their credit card to pay a one-time fee of $0.99 to activate their accounts (http://www.readwriteweb.com/archives/newspaper wants readers to pay to comment.php).

Blogs and news websites, however, are a different Art than social network websites. “Social media networks are, in different degrees, new kinds of platforms that facilitate communication and offer new systems for texting and sending email as well as sharing files. They enable computing through access to different applications and databases” (Michael A. Cusumano. April 2011. Technology Strategy and Management: Platform Wars Come to Social Media. COMMUNICATIONS OF THE ACM 54 (4): 31-33). Blogs and news websites are two-sided platforms (Eisenmann, T., Parker, G. and van Alstyne, M. W. 2006. Strategies for two-sided markets. Harvard Business Review October: 92-101.). Social networking websites for the purposes of this patent are one-sided platforms. Social networking websites are two-sided platforms in the context of games and other third-party content providers, but the present application is limited to interactions between users. On a one-sided platform or in a one-sided market, such as a stock exchange, participants play different roles at different times, e.g., sometimes a buyer, sometimes a seller. In two-sided platforms and markets, participants always play their same roles, e.g., you're always a blogger or you're always a reader. The business differences between the two types of networks are substantial. One-sided platforms can demonstrate direct network effects, but two-sided platforms can demonstrate direct and indirect network effects. Indirect network effects pose a unique set of problems to two-sided markets that are not demonstrated by one-sided markets, such as the chicken-and-egg paradox (e.g., which comes first, software availability or hardware sales?).

U.S. Pat. No. 7,620,636 claims a method in which users can post a comment about a user or to a blog if they donate money to a charity. By definition it is not a method for monetizing a social network by social network provider; it is a method for raising money for charity. Neither does it contemplate charging a fee to upload a file to the social network.

### SUMMARY

The embodiments of the present invention are directed to a method and a system that satisfy the needs set out in the Background section.

The embodiments of the present invention comprise a computer-implemented method enabling a social networking website provider to monetize a social networking website, comprising:
Providing users with a means for performing a first action of using a computer for posting content to a social networking website through a graphical user interface displayed on the social networking website, wherein the means for performing the first action comprises posting a first comment that is not a comment to a comment;
Providing users with a means for performing a corresponding second action of using a computer for posting content to a social networking website through a graphical user interface displayed on the social networking website, wherein the means for performing the second action is selected from the group consisting of posting a subsequent comment to the first comment, posting a file to the first comment, or posting an endorsement to the first comment, wherein a user's account on the social networking website is debited by a fee each time the user performs a second action.

Optionally, the social networking website displays an indicator to each user, wherein the indicator is a component of the social networking website graphical user interface, wherein a user's indicator displays a balance of funds in an account held by the user on the social networking website, wherein the user's indicator decrements proportionately whenever the user's account is debited, wherein the user's indicator increments proportionately whenever the user's account is credited.

Optionally, the indicator is not co-located with content posted in a second action.

Optionally, the indicator is co-located with content posted in a second action.

Optionally, the fee for posting a subsequent comment varies depending on a number of characters in a subsequent comment.

Optionally, the fee for posting a subsequent comment varies depending on colors and boldness and font of characters in the comment.

Optionally, the fee for performing a second action varies depending on a position in which the content is placed in a stack of comments.

Optionally, up to 100% of the fees for performing a second action inure to the benefit of a user who performed a corresponding first action.

Optionally, for each second action performed, a non-monetary reward inures to the benefit of a user who performed the first action.

Additionally, the embodiments of the present invention comprise computer-implemented method enabling a social networking website provider to monetize a social networking website, comprising:
Providing users with a means for performing a first action of using a computer for posting content to a social networking website through a graphical user interface displayed on the social networking website, wherein the means for performing the first action comprises posting a first comment that is not a comment to a comment, wherein a users account on the social networking website is debited by a fee each time the user performs a first action;
Providing users with a means for performing a second action of using a computer for posting content to a social networking website through a graphical user interface displayed on the social networking website, wherein the means for performing the second action is selected from the group consisting of posting a subsequent comment to the first comment, posting a file to the first comment, or posting an endorsement to the first comment, wherein a user's account on the social networking website is debited by a fee each time the user performs a second action.

Optionally, the social networking website displays an indicator to each user, wherein the indicator is a component of the social networking website graphical user interface, wherein a user's indicator displays a balance of funds in an account held by the user on the social networking website, wherein the user's indicator decrements proportionately whenever the user's account is debited, wherein the user's indicator increments proportionately whenever the user's account is credited.

Optionally, the indicator is not co-located with content posted in a first action.

Optionally, the indicator is co-located with content posted in a first action.

Optionally, the indicator is not co-located with content posted in a second action.

Optionally, the indicator is co-located with content posted in a second action.

Optionally, the fee for posting a first comment varies depending on a number of characters in a subsequent comment.

Optionally, the fee for posting a first comment varies depending on colors and boldness and font of characters in the comment.

Optionally, the fee for posting a first comment varies depending on a position in which the content is placed in a stack of comments.

Optionally, the fee for posting a subsequent comment varies depending on a number of characters in a subsequent comment.

Optionally, the fee for posting a subsequent comment varies depending on colors and boldness and font of characters in the comment.

Optionally, the fee for performing a second action varies depending on a position in which the content is placed in a stack of comments.

Optionally, up to 100% of the fees for performing a second action inure to the benefit of a user who performed a corresponding first action.

Optionally, for each second action performed, a non-monetary reward inures to the benefit of a user who performed a corresponding first action.

Additionally, the embodiments of the present invention comprise a social networking website graphical user interface component comprising an indicator, wherein a user of the social networking website interacts with other users of the social networking website through the graphical user interface, wherein the indicator displays a balance of funds in an account held by the user on the social networking website, wherein the user's indicator decrements proportionately whenever the user's account is debited, wherein the user's indicator increments proportionately whenever the user's account is credited.

Optionally, the user can control whether the indicator is visible only to the user.

Optionally, funds are debited from the account held by the user on the social networking website whenever the user posts content to the social networking website.

Optionally, a user's indicator increments and funds are deposited to a user's account whenever a third party comments on or endorses a user's posted content.

Optionally, the indicator displays time remaining to the participant for accessing the social networking website, wherein the indicator begins to decrement at indicator activation, wherein the indicator decrements continuously from indicator activation until indicator depletion.

Optionally, the indicator displays time remaining to the participant for accessing the social networking website, wherein the indicator begins to decrement at indicator activation, wherein the indicator decrements only when the participant is logged in to the social networking website, wherein the indicator ceases to decrement when the participant logs off the social networking website.

Optionally, the indicator is activated by a code input by the user.

Optionally, the indicator is co-located with content posted by the user on the social networking website.

Optionally, the indicator is not co-located with content posted by the user on the social networking website.

Optionally, the indicator fades in and fades out with each increment.

Optionally, the indicator fades in and fades out with each decrement.

The embodiments of the present invention are versatile enough to be combined with numerous other features or options. For example, pay-to-participate can be combined with the current business model, where a user is given the option either to not pay-to-participate but suffer advertisements, or to pay-to-participate and not suffer advertisements. Or pay-to-participate can be used along with advertisements, in the same way that cable TV subscribers still suffer commercials.

The embodiments of the present invention can utilize a deposit account or a checking account, from which the user pays for his posts. The social network provider can utilize a prompt where the user is notified when he posts, for example that the post will cost him five cents and whether he wants to continue. The user can have the option of disabling the prompt. The user might be notified when his deposit account is depleted to a certain level.

Comments can be limited by the social network website to 140 characters as in Twitter, or any other arbitrary amount. Electronic files can also be limited in size, to an arbitrary number of kilobytes or megabytes. The embodiments of the present invention can include additional fees for longer comments or larger files. It can include additional fees for giving priority to comments, for example by printing them in bold and/or color, by displaying and/or maintaining them at a prominent position on the stack of comments or on the page. Comments can also include questions and answers.

### SOME ADVANTAGES OF THE EMBODIMENTS OF THE INVENTION

In the embodiments of the present invention, social networks can increase their revenues, spam would become more expensive to produce. Optional profit sharing incentivizes website participants to adopt the pay-to-participate model.

The risks associated with charging for a previously free service or product are well-known. Here, optional profit sharing not only overcomes objections to the pay-to-participate model; it incentivizes website participants to adopt it and participate in it to their own financial benefit. It is also possible to have a basic free access level with limited functionality, and then other paid levels with enhanced functionality.

The embodiments of the present invention can be used by charities to solicit donations. Namely, a charity can display the indicator on its profile in a social network website, and use the indicator to solicit comments for which it receives a portion of the fees.

These and other advantages will become apparent as the embodiments of the invention are used.

### DRAWINGS

These and other features, aspects and advantages of the embodiments of the device and/or methods will become better understood with reference to the following description, appended claim and accompanying drawings where:

FIG. 1 shows a graphics file with a stack of comments;

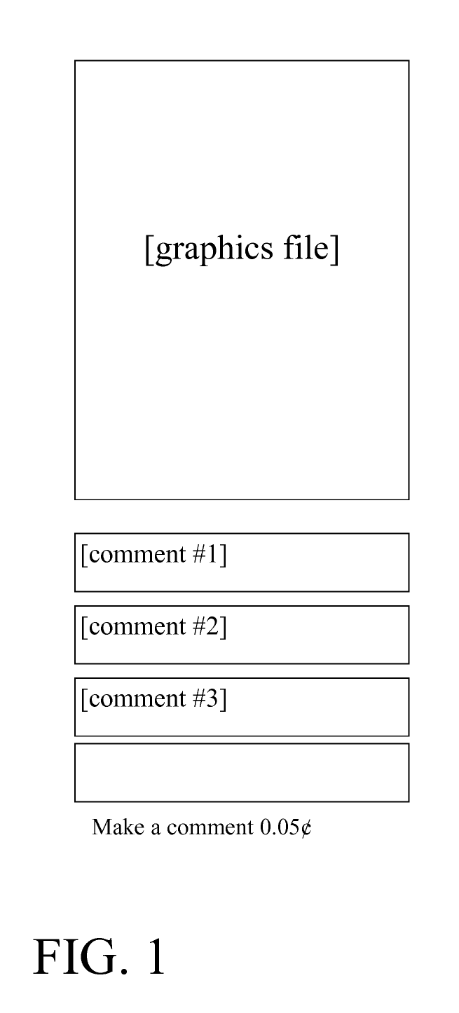

FIG. 2 shows an originating comment with a stack of additional comments;

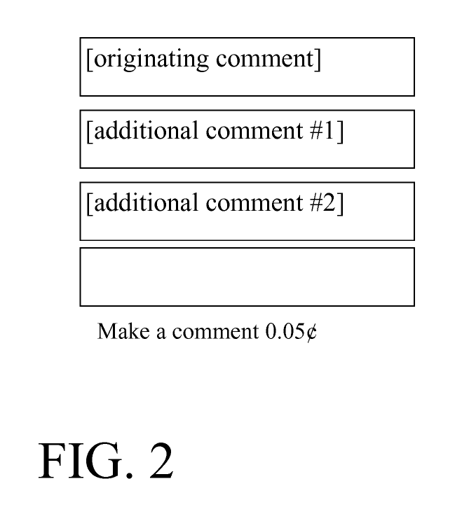

FIG. 3 shows an indicator located in a separate display on a participant's website in a social network.

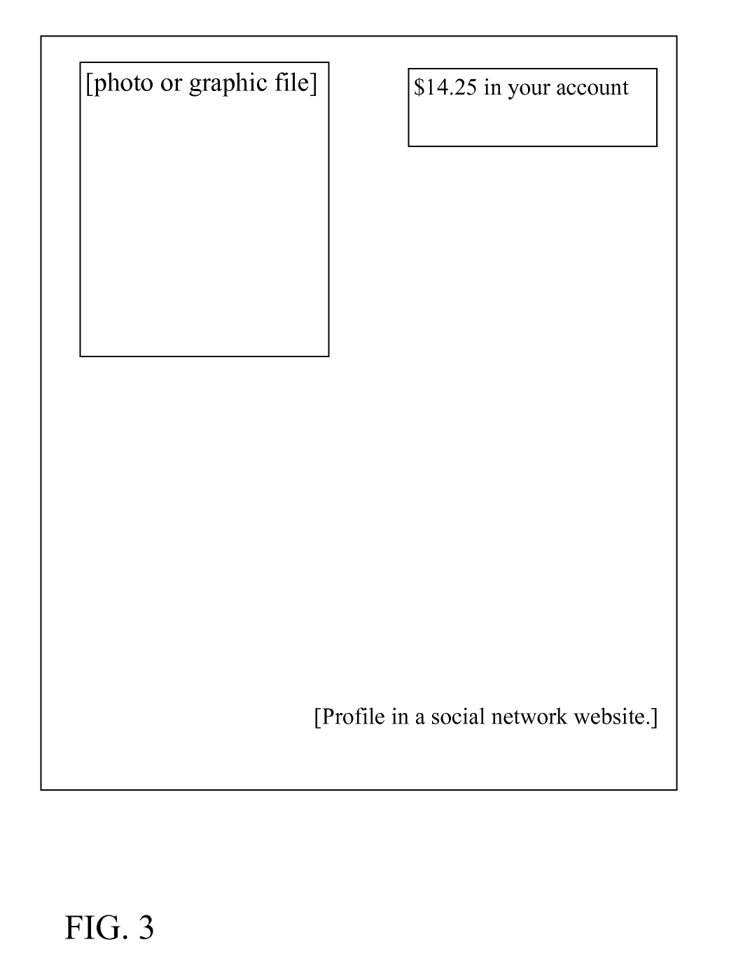

### DESCRIPTION

Definitions

Electronic files include but are not limited to html, text, pdf, gifs, jpegs, audios, videos, and streaming media.

As stated in Wikipedia (http://en.wikipedia.org/wiki/Social networking service), “A social networking service [i.e., website] is an online service, platform, or site that focuses on building and reflecting of social networks or social relations among people, who, for example, share interests and/or activities. A social network service consists of a representation of each user (often a profile), his/her social links, and a variety of additional services. Most social network services are web-based and provide means for users to interact over the Internet, such as e-mail and instant messaging. Online community services are sometimes considered as a social network service, though in a broader sense, social network service usually means an individual-centered service whereas online community services are group-centered. Social networking sites allow users to share ideas, activities, events, and interests within their individual networks. It is also used in today's modern times to meet new people and form relationships such as dating.”

“The main types of social networking services are those that contain category places (such as former school year or classmates), means to connect with friends (usually with self-description pages), and a recommendation system linked to trust. Popular methods now combine many of these, with Facebook and Twitter widely used worldwide, The Sphere (luxury network), Nexopia (mostly in Canada); Bebo, VKontakte, Hi5, Hyves (mostly in The Netherlands), Draugiem.lv (mostly in Latvia), StudiVZ(mostly in Germany), iWiW (mostly in Hungary), Tuenti (mostly in Spain), Nasza-Klasa (mostly in Poland), Decayenne, Tagged, XING, Badoo and Skyrock in parts of Europe; Orkut and Hi5 in South America and Central America; and Mixi, Multiply, Orkut, Wretch, renren and Cyworld in Asia and the Pacific Islands and Facebook, Twitter, LinkedIn and Google+are very popular in India and Pakistan.”

A user of a social network website creates and maintains a profile. An organization such as a charity or a for-profit corporation can create a profile and be a user.

Social networking websites each have a graphical user interface through which users communicate. According to Wikipedia (http://en.wikipedia.org/wiki/Graphical user interface): “In computing, graphical user interface (GUI) is a type of user interface that allows users to interact with electronic devices using images rather than text commands. GUIs can be used in computers, hand-held devices such as MP3 players, portable media players or gaming devices, household appliances, office and industry equipment. A GUI represents the information and actions available to a user through graphical icons and visual indicators such as secondary notation, as opposed to text-based interfaces, typed command labels or text navigation. The actions are usually performed through direct manipulation of the graphical elements.” Typical GUI components are dropdown lists, lists of hyperlinks, tabs, and more.

Each social network provides its own way to perform endorsements, that is, endorse a comment, file, html hyperlink, identity, or something else, on that social network. On Facebook®, you “Like” an identity. On Twitter® you “Follow” an identity. On Google+® you “+1” an identity. On Twitter you can “Retweet” a post, which has the effect of endorsing the post. These examples are not intended to limit the present invention.

### DESCRIPTION OF THE PREFERRED EMBODIMENT AND BEST MODE

As shown in the figures, the preferred embodiment and best mode of the present invention comprise a social networking website graphical user interface component comprising an indicator, wherein a user of the social networking website interacts with other users of the social networking website through the graphical user interface, wherein the indicator displays a balance of funds in an account held by the user on the social networking website, wherein the user's indicator decrements proportionately whenever the user's account is debited, wherein the user's indicator increments proportionately whenever the user's account is credited.

Optionally, the user can control whether the indicator is visible only to the user.

Optionally, funds are debited from the account held by the user on the social networking website whenever the user posts content to the social networking website.

Optionally, a user's indicator increments and funds are deposited to a user's account whenever a third party comments on or endorses a user's posted content.

Optionally, the indicator displays time remaining to the participant for accessing the social networking website, wherein the indicator begins to decrement at indicator activation, wherein the indicator decrements continuously from indicator activation until indicator depletion.

Optionally, the indicator displays time remaining to the participant for accessing the social networking website, wherein the indicator begins to decrement at indicator activation, wherein the indicator decrements only when the participant is logged in to the social networking website, wherein the indicator ceases to decrement when the participant logs off the social networking website.

Optionally, the indicator is activated by a code input by the user.

Optionally, the indicator is an animated needle dial.

Optionally, the indicator is an animated numerical counter.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

We claim:

1. A computer-implemented method enabling a social networking website provider to monetize a social networking website, comprising:
a. Providing users of a social networking website with a means for performing a first action of using a computer for posting content to a social networking website through a graphical user interface displaying the social networking website, wherein the means for performing the first action comprises posting a first comment that is not a comment to a comment;
b. Providing users of a social networking website with a means for performing a corresponding second action of using a computer for posting content to a social networking website through a graphical user interface displaying the social networking website, wherein the means for performing the second action is selected from the group consisting of posting a subsequent comment to the first comment, posting a file to the first comment, or posting an endorsement to the first comment, wherein a user's account on the social networking website is debited by a fee each time the user performs a second action.

2. The computer-implemented method of claim 1, wherein the social networking website displays an indicator to each user, wherein the indicator is a component of the social networking website graphical user interface, wherein a user's indicator displays a balance of funds in an account held by the user on the social networking website, wherein the user's indicator decrements proportionately whenever the user's account is debited, wherein the user's indicator increments proportionately whenever the user's account is credited.

3. The computer-implemented method of claim 1, wherein the fee for posting a subsequent comment varies depending on a number of characters in a subsequent comment.

4. The computer-implemented method of claim 1, wherein the fee for posting a subsequent comment varies depending on colors and boldness and font of characters in the comment.

5. The computer-implemented method of claim 1, wherein the fee for performing a second action varies depending on a position in which the content is placed in a stack of comments.

6. The computer-implemented method of claim 1, wherein up to 100% of the fees for performing a second action inure to a benefit of a user who performed a corresponding first action.

7. The computer-implemented method of claim 1, wherein for each second action performed, a non-monetary reward inures to the benefit of a user who performed the first action.

8. A computer-implemented method enabling a social networking website provider to monetize a social networking website, comprising:
a. Providing users of a social networking website with a means for performing a first action of using a computer for posting content to a social networking website through a graphical user interface displaying the social networking website, wherein the means for performing the first action comprises posting a first comment that is not a comment to a comment, wherein a user's account on the social networking website is debited by a fee each time the user performs a first action;
b. Providing users of a social networking website with a means for performing a second action of using a computer for posting content to a social networking website through a graphical user interface displaying the social networking website, wherein the means for performing the second action is selected from the group consisting of posting a subsequent comment to the first comment, posting a file to the first comment, or posting an endorsement to the first comment, wherein a user's account on the social networking website is debited by a fee each time the user performs a second action.

9. The computer-implemented method of claim 8, wherein the social networking website displays an indicator to each user, wherein the indicator is a component of the social networking website graphical user interface, wherein a user's indicator displays a balance of funds in an account held by the user on the social networking website, wherein the user's indicator decrements proportionately whenever the user's account is debited, wherein the user's indicator increments proportionately whenever the user's account is credited.

10. The computer-implemented method of claim 8, wherein the fee for posting a first comment varies depending on a number of characters in a subsequent comment.

11. The computer-implemented method of claim 8, wherein the fee for posting a first comment varies depending on colors and boldness and font of characters in the comment.

12. The computer-implemented method of claim 8, wherein the fee for posting a subsequent comment varies depending on a number of characters in a subsequent comment.

13. The computer-implemented method of claim 8, wherein the fee for posting a subsequent comment varies depending on colors and boldness and font of characters in the comment.

14. The computer-implemented method of claim 8, wherein the fee for performing a second action varies depending on a position in which the content is placed in a stack of comments.

15. The computer-implemented method of claim 8, wherein up to 100% of the fees for performing a second action inure to a benefit of a user who performed a corresponding first action.

16. The computer-implemented method of claim 8, wherein for each second action performed, a non-monetary reward inures to a benefit of a user who performed a corresponding first action.

17. A social networking website graphical user interface component comprising an indicator, wherein a user of the social networking website interacts with other users of the social networking website through the graphical user interface, wherein the indicator displays a balance of funds in an account held by the user on the social networking website, wherein the user's indicator decrements proportionately whenever the user's account is debited, wherein the user's indicator increments proportionately whenever the user's account is credited.

18. The graphical user interface component of claim 17, wherein the user can control whether the indicator is visible only to the user.

19. The graphical user interface component of claim 17, wherein funds are debited from the account held by the user on the social networking website whenever the user posts content to the social networking website.

20. The graphical user interface component of claim 17, wherein a user's indicator increments and funds are deposited to a user's account whenever a third party comments on or endorses a user's posted content.

21. The graphical user interface component of claim 17, wherein the indicator displays time remaining to the participant for accessing the social networking website, wherein the indicator begins to decrement at indicator activation, wherein the indicator decrements continuously from indicator activation until indicator depletion.

22. The graphical user interface component of claim 17, wherein the indicator displays time remaining to the participant for accessing the social networking website, wherein the indicator begins to decrement at indicator activation, wherein the indicator decrements only when the participant is logged in to the social networking website, wherein the indicator ceases to decrement when the participant logs off the social networking website.

23. The graphical user interface component of claim 17, wherein the indicator is activated by a code input by the user.

24. The graphical user interface component of claim 17, wherein the indicator is an animated needle dial.

25. The graphical user interface component of claim 17, wherein the indicator is an animated numerical counter.
